(19) United States
(12) Patent Application Publication
(10) Pub. No.: US 2026/0065783 A1
(43) Pub. Date: Mar. 5, 2026

(54) SYSTEM AND METHOD FOR REAL-TIME TRAFFIC MANAGEMENT

(71) Applicant: B.G. NEGEV TECHNOLOGIES AND APPLICATIONS LTD., AT BEN GURION UNIVERSITY, Beer-Sheva (IL)

(72) Inventors: Shlomi DOLEV, Omer (IL); Ehud GUDES, Kfar-Sava (IL); Hannah YAIR, Patish (IL)

(21) Appl. No.: 18/877,891

(22) PCT Filed: Jun. 29, 2023
(86) PCT No.: PCT/IL2023/050678

§ 371 Date: Dec. 20, 2024

Related U.S. Application Data
(60) Provisional application No. 63/356,489, filed on Jun. 29, 2022.

(51) Int. Cl. G08G 1/00; G08G 1/052; G08G 1/056; G08G 1/08; G08G 1/0967

(52) U.S. Cl. CPC G08G 1/22; G08G 1/052; G08G 1/056; G08G 1/08; G08G 1/096725; G08G 1/096766; G08G 1/20

(57) ABSTRACT

A method for efficient real-time traffic management of controllable autonomic and non-autonomic vehicles, moving between sources and destinations, comprising scheduling and synchronizing the movement of autonomic and non-autonomic vehicles approaching junctions between source and destination; displaying to the driver of each non-autonomic vehicle or transmitting to each autonomic vehicle, the speed required for allowing the vehicle to cross each junction without stopping, while eliminating conflicts with other vehicles, for achieving non-stop junctions; scheduling and synchronizing the movement of a plurality of vehicles that join and leave the traffic, for allowing a non-stop movement from source to destination.

### FIELD OF THE INVENTION

The present invention relates to the field of vehicular traffic management. More particularly, the invention relates to a system and method for efficient real-time traffic management in junctions and lanes connecting between sources and destinations of moving vehicles.

### BACKGROUND OF THE INVENTION

Managing and scheduling transportation at junctions and crossroads efficiently while minimizing travel time is a challenging task. One of the main goals is to find policies and algorithms to schedule vehicles through junctions without the need to wait for a green light at the junction, which causes traffic jams and delays the overall flow of traffic on the road.

The assistance of a computer system can leverage the capabilities of single procedures to be applied to a group of autonomous vehicles' procedures that when executed on the controlling computer initiates commands to many autonomous vehicles in parallel. In particular, such procedures are based on the concept of platoons and traffic policies.

A platoon is defined as a group of vehicles moving in the same direction as a selected vehicle, called, the representative vehicle, and at a distance of each other which is less than a given threshold. The meaning behind traffic policies in a remotely controlled autonomous environment is giving remote instructions to autonomous vehicles on the road and called virtual traffic policies.

The advantages of creating a platoon are well-known and include increased safety and fuel saving, and virtual traffic policies are liable for virtually managing and scheduling transportation. Als, scheduling traffic is important since it helps to ensure the safety of drivers, passengers, and pedestrians on the roads. By regulating the flow of traffic, authorities can reduce the risk of accidents and minimize the impact of congestion on emergency services. Additionally, efficient traffic management can improve air quality by reducing the time cars spend idling in traffic, thereby reducing hazardous emissions. By optimizing traffic flow, authorities can increase the overall efficiency of transportation systems, while reducing travel times and facilitating efficient movement of goods and services.

It is therefore an object of the present invention to provide a system and method for efficient real-time traffic management between sources and destinations of moving vehicles.

It is another object of the present invention to provide a system and method for efficient real-time traffic management using computer initiates commands to many autonomous vehicles in parallel.

It is another object of the present invention to provide a system and method for efficient real-time traffic management, with increased safety and fuel saving.

It is a further object of the present invention to provide a system and method for efficient real-time traffic management, while reducing the risk of accidents and minimizing the impact of congestion on emergency services.

It is still another object of the present invention to provide a system and method for efficient real-time traffic management while reducing hazardous emissions and optimizing traffic flow, to increase the overall efficiency of transportation systems.

It is yet another object of the present invention to provide a system and method for efficient real-time traffic management, while allowing all vehicles to move without stopping at junctions between source and destination.

Other objects and advantages of the invention will become apparent as the description proceeds.

### SUMMARY OF THE INVENTION

A method for efficient real-time traffic management of controllable autonomic and non-autonomic vehicles, moving between sources and destinations, comprising:
a) scheduling and synchronizing the movement of autonomic and non-autonomic vehicles approaching junctions between source and destination;
b) displaying to the driver of each non-autonomic vehicle or transmitting to each autonomic vehicle, the speed required for allowing the vehicle to cross each junction without stopping, while eliminating conflicts with other vehicles, for achieving non-stop junctions; and
c) scheduling and synchronizing the movement of a plurality of vehicles that join and leave the traffic, for allowing a non-stop movement from source to destination.

The method may further comprise the steps of:
a) collecting data regarding source and destination of each vehicle;
b) generating for each vehicle, based on the data collected for all other vehicles, an optimal path from its corresponding source to destination that allows a non-stop movement from source to destination.

A method for efficient real-time traffic management of controllable vehicles belonging to a platoon in a predetermined area, comprising:
a) converting a map of the predetermined area to a directed graph;
b) selecting a representative vehicle for the platoon;
c) associating all vehicles being transitively closer to each other than a predetermined distance from the representative vehicle, to the platoon; and
d) tracking and replaying the movements of each vehicle in the platoon upon reaching the location of the representative vehicle.

A method for efficient real-time traffic management of controllable vehicles belonging to a platoon, comprising:
a) collecting the location data of each controllable vehicle to construct a map;
b) converting the map to a directed graph, the node of which represent junctions and the edges of which represent lanes;
c) for each vehicle in the platoon, determining a corresponding edge in the directed graph and a corresponding location on the edge;
d) selecting a representative vehicle for the platoon;
e) scanning all vehicles in the directed graph that move in the same direction as the representative vehicle;
f) scanning all vehicles in the directed graph that move along edges that merge with the edge of the representative vehicle;
g) generating a platoon by including all vehicles, the distance of which from a vehicle in the platoon, where the first vehicle in the platoon is the representative vehicle is below a predetermined threshold, as belonging to the platoon;
h) selecting the first vehicle in the platoon as a leading vehicle; and
i) sending movement commands to leading and allowing the other vehicles and to follow the leading vehicle as a firming vehicle being alternative to a train.

The method may further comprise the steps of generating virtual traffic policies including real-time generation of virtual signs that are transmitted or displayed to each controllable vehicle from a traffic management center and/or a programmable road sign.

A method for real-time traffic management of controllable vehicles approaching a junction to pass the junction without stopping, comprising:
a) at each predetermined time unit, generating batches of vehicles being closer than a predetermined distance D from the junction, where each batch comprises vehicles with possibly known approaching lane and direction;
b) for each junction, generating a table of layers, each of which containing vehicles that can cross the junction without conflicts;
c) checking if vehicles from a later batch can enter lanes of other layers and if they can, allowing the vehicles to enter the lanes;
d) for each approaching vehicle, calculating the moving speed for approaching the junction, such that the approaching vehicle will cross the junction safely without stopping and without conflicts with other approaching vehicles; and
e) transmitting and/or display, in a programmable road sign, to each approaching vehicle the correct timing for safely crossing the junction.

The table of layers may be generated in a preprocessing offline, using dynamic programming.

A method for global real-time traffic management for scheduling vehicles entrance to the traffic to reach its destination without stopping, comprising:
a) collecting the location data of each controllable vehicle either via direct communication or via satellites, airplane, drones or cameras to construct a map;
b) converting the map to a directed graph, the node of which represent junctions and the edges of which represent lanes;
c) identifying potential conflict points on the directed graph;
d) splitting each conflict point to an additional edge, to generate a split graph that enforces respecting one vehicle at a time in all conflicting locations;
a) at each predetermined time unit, scheduling the arriving batch of vehicles to start a journey from a source, being the location to a destination;
b) generating a table of layers, each of which containing vehicles that can cross the junction without conflicts;
c) for each source and destination, seeking the shortest path on the split graph that connects between source and destination, while eliminating edges, via which a vehicle has passed during a preceding time unit; and
d) for each vehicle in a batch, determining the timing at which the vehicle crosses each junction without conflicts with other vehicles.

Finding the shortest path may be performed using the Dijkstra's Algorithm.

The timing may be determined using the Multi commodity Flow Based Algorithm, by:
a) transferring a single execution of multi commodity flow into a continuous execution of multi-commodity flow by introducing new intermediate nodes into the graph, such that a vehicle can start from the intermediate nodes, if the vehicle reached the node after one time unit since the previous computation of the multi commodity flow solution, the multicommodity flow allows maximum flow of vehicles through the network; and
b) postponing the entrances of new vehicles that cause a delay in the arrival time of vehicles that started their journey.

The virtual traffic policies comprise one or more of the following:
the same driving instructions given to the leading vehicle at a particular point along the road are given to the other platoon members when they arrive at the same particular point;
all the vehicles in the platoon get the same Maximum Speed limit;
all the vehicles in the platoon which are on the same lane will move at the same speed;
Lane blocking for all kind of vehicles;
Distance keeping among vehicles in a platoon;
Reversing lane direction;
directing vehicle to use detour through emergency lanes and reversed lane of the opposite direction road;
using Virtual Traffic Lights;
real-time generation of virtual signs that are transmitted to each controllable vehicle from a traffic management center and/or a programmable road sign.

Determining the timing may be done such that priority between the lanes entering the junction is equal.

The table may comprise all possible batches with precomputed optimal separation into layers for each batch.

Scheduling may be performed by:
a) at each given time-unit t, collecting all of the vehicles that are close to the junction at distance D;
b) for every vehicle in a batch, checking the possibility of joining to an existing layer that was received by the previous batches scheduling their crossing time;
c) allowing vehicles from a current batch to join previous layers;
d) updating the current batch with a reduced set of vehicles;
e) obtaining the optimal separation into new layers from the table, for the remaining vehicles;
f) determining the crossing time T for each layer;
g) For each layer in the current batch that has passed the junction, setting an indication when the junction is empty; and
h) updating the vehicle velocity by the distance and their calculated crossing time.

A method for determining platoons of vehicles, comprising performing transformation of a location map into measurements of a distance between vehicles, being a function of the speed of the vehicle, measuring speed by tracing location and time to notify nearby vehicles on the opportunity to a platoon, by speeding or slowing down.

The distance and speed may be used to determine a safety distance for each vehicle while crossing a junction.

The threshold distance to join a platoon may be larger than the distance between consecutive vehicles but is sufficiently small for encouraging vehicles behind the platoon to accelerate and vehicles in front of the platoon to decelerate and join the platoon.

The platoon may consist of a plurality of trucks operated by transport services providers that are jointly controlled to travel from a source to a destination.

A system for efficient real-time traffic management of controllable autonomic and non-autonomic vehicles, moving between sources and destinations, comprising:
a) a computerized device comprising at least one processor, for scheduling and synchronizing the movement of autonomic and non-autonomic vehicles approaching junctions between source and destination;
b) a display device, controlled by commands sent from the computerized device, for displaying to the driver of each non-autonomic vehicle or transmitting to each autonomic vehicle, the speed required for allowing the vehicle to cross each junction without stopping, while eliminating conflicts with other vehicles, for achieving non-stop junctions; and
c) scheduling and synchronizing the movement of a plurality of vehicles that join and leave the traffic, for allowing a non-stop movement from source to destination.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates the algorithm operation by three arrows that describe the calculation of the platoon members;

FIG. 2 depicts the equal order of priority between all lanes entering the junction;

FIG. 3 illustrates an example of a junction with marks of the definition c(lᵢ);

FIG. 4 presented the transformation of part of the SUMO simulation map;

FIG. 5 presents an example of two junctions and the transformation to the conflict graph with the marking of the conflicts for each node;

FIG. 6 shows the execution result during 3000 time-units;

FIG. 7 illustrates the process of creating the graph;

FIG. 8 shows the split of edges in the variant graph, which corresponds to the variant graph shown in FIG. 7;

FIG. 9a shows an example of an arbitrary split graph;

FIG. 9b shows the transformation to layers graph

FIG. 10 shows an example of a pair of source and destination and the route network transformation; and

FIG. 11 shows an example of a flow network transformation.

### DETAILED DESCRIPTION OF THE INVENTION

The present invention provides a system and method for efficient real-time traffic management in junctions and lanes connecting between sources and destinations of moving vehicles, by creating and joining platoons, based on a distance threshold and the road topology, while presenting a new dynamic and history-agnostic definition of platoons and the control of transportation by virtual traffic policies that focus on virtual traffic lights policy for a single junction, as well as for several junctions.

A platoon is defined as a group of vehicles moving in the same direction around a selected representative vehicle. The platoon consists of every vehicle that is at a distance less than a threshold distance from a vehicle that belongs to the platoon.

### The Platoon Generating Algorithm:

At the first step, a scheme is built, that represents the map area as a directed graph with nodes that are junctions and the edges that represent the lanes connecting the junctions. This scheme is built by utilizing the transformation part of the SUMO simulator [1], which can be based on google maps to a directed graph. When the representative vehicle R is received, the information of R and the vehicles that are on the same edge of R are collected. This information is then sorted into two groups pos, neg where pos is the group of vehicles in front of R and neg includes the cars that are behind R. These groups were built in an iterative fashion, while adding all vehicles that are within the threshold distance from the last added vehicles. Once all the vehicles on the current edge are considered, the platoon calculation propagates along the edges that are adjacent to the edge R.

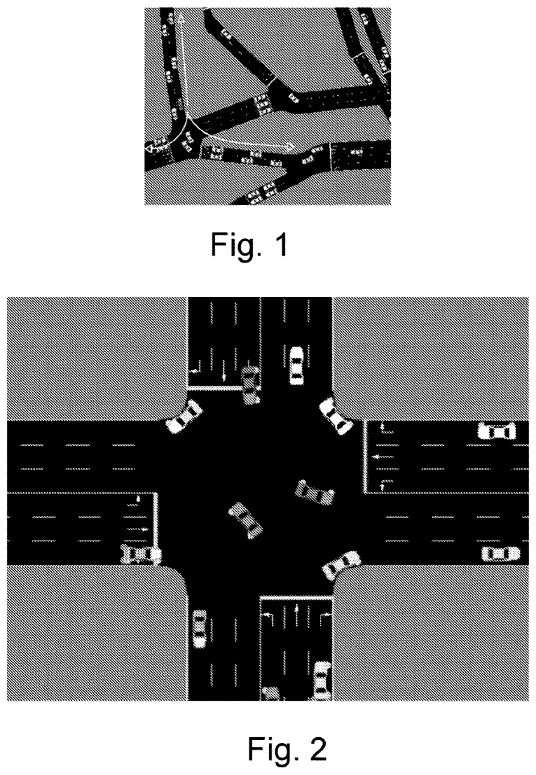

FIG. 1 illustrates the algorithm operation by three arrows that describe the calculation of the platoon members. One straight arrow with the red vehicle direction describes the calculation operation of the members in front of the red vehicle, and the two other arrows describe the calculation operation of the members that are behind the red vehicle.

### Traffic Signs Policies

The policies can be used by a traffic controller at a control center, which receives information on road conditions, accidents, traffic jams, etc., throughout an entire region. The virtual signs can control the platoon's movements and enable a smoother traffic flow overall by solving unusual conditions.

### Policies List

### Follow the Leader:

$$( pltnSign ( Follow , p ) = the vehicles in platoon p follow the leader \qquad ( 1 )$$

Leading a group of vehicles traveling on the same route when the first vehicle in the platoon is driven by the remote driver and the rest of the vehicles follow the vehicle's behavior of those that are in front of them. Namely, driving instructions given by the human driver to the leading vehicle at a particular point along the road are given to the other platoon members when they arrive at the same particular point. This saves the number of human remote drivers to drive vehicles.

### Speed Limit for a Platoon:

$$pltnSign ( maxSpeed , p ) = speed limit vehicles in platoon p \qquad ( 2 )$$

All the vehicles in the platoon get the same value for the attribute “Max Speed”. This implies safe driving when high speed is dangerous, e.g., after a cargo vehicle or school bus.

### Speed Limit on a Lane for a Platoon:

$$pltnSign ( maxSpeed , p , l ) = speed limit vehicles in platoon p on lane l \qquad ( 3 )$$

All the vehicles in the platoon which are on the lane will follow the same speed that is assigned to the attribute “Max Speed”. This allows safe driving, while switching lanes, avoiding dangerous (e.g., left) overtaking.

### Lane Block for all Kind of Vehicles:

$$laneSign ( block , l ) = no entry to lane l \qquad ( 4 )$$

All the vehicles in the simulation cannot enter the lane. When an unexpected or dangerous problem occurs e.g., on the lane like the presence of a pothole or oil.

### Distance Keeping Among Vehicles in a Platoon:

$$pltnSign ( minGap , p ) = safe distance limit vehicles in platoon p \qquad ( 5 )$$

All vehicles maintain the same gap in the platoon which is assign/defined to/by the attribute “Min Gap”. For example, safe driving in obscure air or crowded lane.

### Virtual Traffic Lights:

$$VTLSign ( junction , type ) = schedule the up coming vehicles \qquad ( 6 )$$

The traffic policies will be controlled and changed according to the scenario by several algorithms.

The main idea of the Virtual Traffic Lights is to synchronize the vehicles coming to the junction in such a way that vehicles do not stop at all to let others cross the junction or wait for others to evacuate the junction. Under the assumption that all vehicles on the road are autonomous and computer-controlled, the solution for Virtual Traffic Lights is early handling of junction management. Therefore, calculating the timing at a reasonable distance D before the junction and maintaining a sufficient distance between the vehicles before the junction, allows flexibility of deceleration or acceleration of the vehicles in order for them to cross the junction as safely and quickly as possible.

The timing principle is “first come, first served”. The vehicles that are closer to the junction by a given distance D are the ones that are timed first crossing the junction. Additionally, the vehicles arriving at the junction will cross it at high speed to evacuate the junction as quickly as possible. Thus, there is no case of excessive deceleration that could cause an abnormal traffic load in a particular lane entering the junction. The order of priority between the lanes entering the junction is equal.

For the platoons mentioned above that cross the junction in the presented policy, the only vehicles leaving the platoon are vehicles that turned in a different direction than the direction of the representative vehicle. This is because all lanes are given equal priority for crossing the junction, and vehicles are not allowed to stop on the road. Consequently, the distance between the vehicles in the platoon that turn in the same direction as the representative vehicle may slightly increase, which will help prevent the platoon from disintegrating.

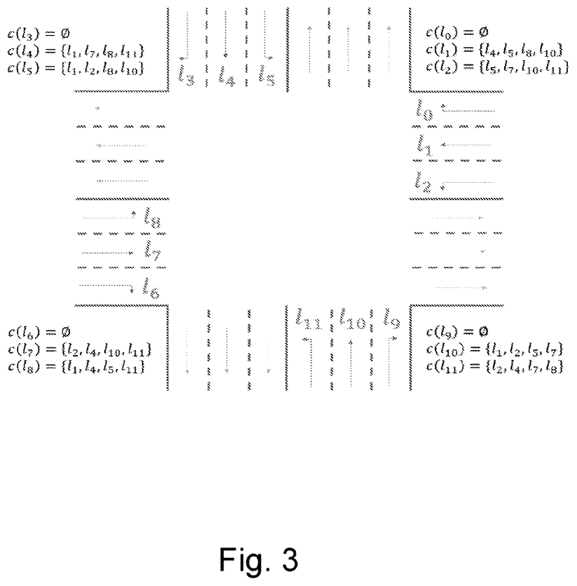

FIG. 2 shows a snapshot from the algorithm for vehicle synchronization running at a non-stop junction slightly describes the zipper situation, and it is apparent that the lights in all directions at the junction are green. FIG. 2 depicts the equal order of priority between all lanes entering the junction. In practice, there is no need for a physical traffic light.

### Virtual Traffic Light Algorithm

The algorithm utilizes the junction as much as possible i.e., as many vehicles as possible cross the junction together, as fast as possible. Most important, it does not cause vehicles to stop before or at a junction but only cause them to move slightly slower.

### Definitions

lanes is defined as the set of all lanes entering the junction.
c(lᵢ) is defined as the group of lanes that lane lᵢ has conflict with.
D is defined as the distance threshold from the entries of the junction along the lanes.

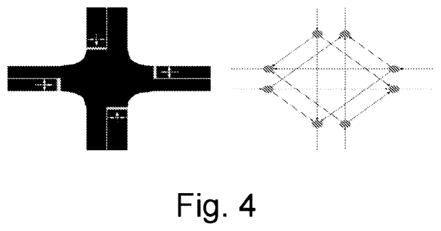

FIG. 3 illustrates an example of a junction with marks of the definition c(lᵢ). Where the lanes' length is D (and possibly they are parts of the whole lanes), note that size of lanes=12.

### Batches and Layers

batchₜ is the group of vehicles that are currently present exactly in a distance D (or smaller) in the time-unit t.
layerₜ is defined as a subset of vehicles belonging to batch, that can arrive at the junction at the same time and can cross it without collisions.

The objective is to maximize the size of the layers and create a minimum number of layers from a batch. For each batch, we look at all possible subsets of vehicles of the batch called a layer, while searching for a set of layers that will optimize the average waiting time of vehicles in a batch. A table for all possible batches is created, and for each such batch, the optimal set of layers is generated.

Table 2 illustrates of the definitions of batch, layer according to the above example.

TABLE 2

| | 0 | 1 | 2 | 3 | 4 | 5 | 6 | 7 | 8 | 9 | 10 | 11 |
|---|---|---|---|---|---|---|---|---|---|---|---|---|
| Batchₜ | | X | X | X | X | | X | X | | X | | X |
| Layer_{T}_{₁} | | X | X | X | | | X | | | X | | |
| Layer_{T}_{₂} | | | | | X | | | | | | | |
| Layer_{T}_{₃} | | | | | | | | X | | | | |
| Layer_{T}_{₄} | | | | | | | | | | | | X |
| Layer_{T}_{₁} | | X | | X | | | X | X | | X | | |
| Layer_{T}_{₂} | | | X | | X | | | | | | | |
| Layer_{T}_{₃} | | | | | | | | | | | | X |

The columns describe the lanes in the junction, and the rows describe batches or layers. In the batchₜ row, the marks x describe in which lanes there are vehicles. In the layer_{T}_{ᵢ} rows, the marks x describe from which lanes vehicles are joining to that layer_{T}_{ᵢ} and, the colored blank spaces describe the conflicts with the elements of the layer_{T}_{ᵢ}. In addition, every group of rows with the same color denotes an option of valid separation into layers. However, the orange rows denote the optimal solution since the average waiting time is minimal.

The goal of the algorithm is to create a table of all possible batches (exponential in size), and generate the optimal division into layers. The problem of finding the optimal separation into layers for a batch is NP-hard and does not have a polynomial solution that is both efficient and accurate. Since the number of lanes is relatively small, all possible subsets of a batch are considered and for each batch, the optimal set of subsets id found, which is defined as the set of layers.

First, define the function c(lᵢ) that defines the group of lanes that lane lᵢ has a conflict with.

Second, using the function c(lᵢ), the table S is calculated, which contains the optimal separation into layers for every possible batch, where the optimal separation is the separation, which gives the minimum average waiting time. The calculation method of table S is by dynamic programming and is presented in Algorithm 1.

Algorithm 1: buildSeparationsTable(lanes, c):

| | Result: Build the separations table for any possible batch | | | | |
|---|---|---|---|---|---|
| 1 | B = reveresedSorted(P(lanes)) | | | | |
| 2 | L = φ | | | | |
| 3 | for b ∈ B do | | | | |
| 4 | \| | if ∀ e ∈ b : {c(e) ∩ b \ {e}} = φ then | | | |
| 5 | \| | \| | flag = true | | |
| 6 | \| | \| | for l ∈ L do | | |
| 7 | \| | \| | \| | if b ⊆ l then | |
| 8 | \| | \| | \| | \| | flag = false |
| 9 | \| | \| | \| | \| | break |
| 10 | \| | \| | \| | end | |
| 11 | \| | \| | end | | |
| 12 | \| | \| | if flag then | | |
| 13 | \| | \| | \| | L = L ∪ b | |
| 14 | \| | \| | end | | |
| 15 | \| | end | | | |
| 16 | end | | | | |
| 17 | S = Matrix [\| lanes \|][*] | | | | |
| 18 | S[0] = φ | | | | |
| 19 | ∀ l ∈ lanes : S[1][l] = {l} | | | | |
| 20 | for batch ∈ reveresed(B) do | | | | |
| 21 | \| | layers = φ | | | |
| 22 | \| | cost = ∞ | | | |
| 23 | \| | for layer ∈ L do | | | |
| 24 | \| | \| | layer′ = batch ∩ layer | | |
| 25 | \| | \| | if layer′ ≠ φ then | | |
| 26 | \| | \| | \| | batch′ = batch \ layer′ | |
| 27 | \| | \| | \| | layers′ = S[\| batch′ \|][batch′] | |
| 28 | \| | \| | \| | layers′ = layers′.appendFirst(layer′) | |
| 29 | \| | \| | \| | newCost = Σᵢ₌₁^{\|layers′\|} \| layerᵢ \| α · i : layeᵢ ∈ layers′ | |
| 30 | \| | \| | \| | if newCost < cost then | |
| 31 | \| | \| | \| | \| | cost = newCost |
| 32 | \| | \| | \| | \| | layers = layers′ |

| | | | | |
|---|---|---|---|---|
| 33 | \| | \| | \| | end |

| | | | |
|---|---|---|---|
| 34 | \| | \| | end |

| | | |
|---|---|---|
| 35 | \| | end |
| 36 | \| | S[\| batch \|][batch] = layers |

| | |
|---|---|
| 37 | end |
| 38 | return S |

The way of calculating the minimum average waiting time could be by many different heuristic/approximation algorithms which give an estimated solution in a more efficient way. However since L is small and constant then, it is better to get an inefficient but accurate solution than an estimated solution with an efficient calculation time.

Algorithm 2 describes the building of the separation table S in details.

Algorithm 2: scheduleJunction(junction):

| | Result: schedule a junction according to the specific conflict graph | | |
|---|---|---|---|
| 1 | clearIndicator=currentTime | | |
| 2 | previousLayers = φ | | |
| 3 | S =buildSeparationsTable(junction.gatLanes( ) ,junction.getC( )) | | |
| 4 | for time in timeUnit do | | |
| 5 | \| | batch =collect all the closest vehicles. | |
| 6 | \| | scheduleInToPreviousLayers(batch, previousLayers) | |
| 7 | \| | layers = S[\| batch \|][batch] | |
| 8 | \| | for layer ∈ layers do | |
| 9 | \| | \| | arrivalTime=changeVelocity(layer, clearIndicato) |
| 10 | \| | \| | previousLayers = previousLayers ∪ (layer, arrivalTime) |
| 11 | \| | \| | clearIndicator = arrivalTime + α |

| | | |
|---|---|---|
| 12 | \| | end |

| | |
|---|---|
| 13 | end |

Algorithm 2 computes the optimal set of layers and stores them in the table for each possible batch. Table S is built once for each junction and then is used directly by the scheduling algorithm. The scheduling algorithm works as follows:

First, at each given time-unit t, all of the vehicles that are close to the junction at distance D are collected (batchₜ) and scheduled in the following way.

Next, for every vehicle in the batchₜ check the possibility of joining to an existing layer that was received by the previous batches and schedule their crossing time by the parameter T of the layer_{T} that they join to. After enabling vehicles from the current batch to join previous layers, the current batch is updated with a reduced set of vehicles. Then, for the remaining vehicles (the vehicles that cannot join to any previous layers) the optimal separation into new layers is obtained from the table S. A schedule for those layers is built thereafter with the necessary crossing time T for each layer. For each layer in the current batch that has passed the junction, the parameter clearIndicator which indicates when the junction is empty, is set. Finally, it is required to update the vehicle velocity by the distance and their calculated crossing time. This is presented in Algorithm 2.

Table 3 presents scheduling layers and a sample solution of three iterations of the algorithm, where the junction is according to the example presented in FIG. 3.

TABLE 3

| | 0 | 1 | 2 | 3 | 4 | 5 | 6 | 7 | 8 | 9 | 10 | 11 |
|---|---|---|---|---|---|---|---|---|---|---|---|---|
| Batchₜ | | X | | X | X | | X | X | | X | | X |
| Layer_{T}_{₁} | X | X | | X | | | X | X | | X | | |
| Layer_{T}_{₂} | | | | X | X | | X | | | X | X | |
| Layer_{T}_{₃} | | X | | X | | | X | | | X | | X |
| Batchₜ₊₁ | X | X | | X | X | | X | X | | X | X | |
| Layer_{T}_{₄} | | | | | X | X | | | | | | |
| Layer_{T}_{₅} | | X | | | | | | X | | | | |
| Batchₜ₊₂ | | X | | X | | X | X | | X | X | X | X |
| Layer_{T}_{₆} | | | | | | | | | X | | X | |
| Layer_{T}_{₇} | | | | | | | | | | | | X |

Every color in the Table 3 means an iteration in the illustration. The columns describe the lanes in the junction, and the rows describe batches or layers. In the batchₜ₊ᵢ rows, the marks x describe in which lanes there are vehicles. In the layer_{T}_{ᵢ} rows, the marks x describe from which lanes vehicles are joining that layer_{T}_{ᵢ} and, the colored blank spaces describe the conflicts with the elements of the layer_{T}_{ᵢ}. The color of the marks x and the colored blank spaces are related to the iteration they joined and the conflicts of the elements with the same color. As can be seen that in Table 3, for the first batch, layer 1 collects vehicles in lanes: 1, 3, 6, 7, 9, layer 2 collects vehicles from lane 4, and layer 3 collects vehicles from lane 11. The orange “x” indicates vehicles that joined from a later batch (e.g. vehicle in lane 0 in layer 1).

Table 4 contains the notation for understanding the algorithms below.

TABLE 4

| Parameter | Definition |
|---|---|
| P(A) | Function that returns a set of all subsets of group A |
| B | Set of all possible batches sorted in descending order of size |
| L | Set of all the largest layers for this junction |
| S | Matrix with m rows and n columns, where m represents |
| | the number of lanes that is, every row i: 0 ≤ i ≤ m defines |
| | batches with size i and, n represents the number of the |
| | different batches with the same size, that is, for every row |
| | i: 0 ≤ i ≤ m the number of columns is different and equal to |
| | the number of the different batches with size i |
| cost | Value of the minimum waiting time for the entire batch |

Algorithm 1 builds the separations table S that includes the optimal separation to layers for any possible batch. The algorithm scans all the possible batches which are sorted by size in ascending order. When a batch of size K is processed, all the batches of smaller size were already processed, and therefore, it is possible to use their division to optimal layers which are already in the table.

First, the algorithm computes the set L which is a set (group) of all possible divisions of the set of lanes in the junction into maximal size layers (i.e. a layer that is not contained in another layer). Next for each such set of subsets, the algorithm computes the maximum waiting time, and the set of layers selected is the one with the minimum of that waiting time.

In the first part of the algorithm, it calculates all the possible batches set B, by making all the possible subsets from the lanes set which is given as an argument, and creates a descending sorting order of this group in size of the subsets.

In the second part of the algorithm, it calculates the group L that is described above, by scanning the sorted list B (all the possible batches) and collecting all the elements that can form a layer (that is, a subset without conflicts) which is not already included in any other bigger layer.

In the third part of the algorithm, it calculates the table S. In the beginning, the table S is defined and is initialized with the separation to layers for all the trivial batches (the batches with size 0 or 1). Next, it scans the list B in ascending order in size and performs the separation into layers by choosing the separation among all possible separations which gives the minimum waiting time (denoted as), where a is the time of crossing the junction. Note that changing the objective to the minimum number of layers will not change much in the algorithm, only the sum. The manner in which the optimal separation for each batch is calculated is by separating the batch into one possible layer and then taking the optimal separation for the rest of the batch from the corresponding part of table S that was calculated earlier.

Algorithm 2 schedules a junction according to the specific separations table. The algorithm decides when the vehicles cross the junction for every time unit. In each time unit, several vehicles are crossing the junction from the current batch, and new vehicles may join the next batch. The next batch is also partitioned into layers, which are scheduled after the layers of the previous batch. The vehicles of the next layer need to be slowed down according to the clearIndicator. For example, if the current layer will take 40 sec to cross the junction, the next layer needs to be slowed down so that it will arrive at the junction 40 sec after that. The algorithm enables another optimization by allowing vehicles in the next batch to speed up and join the current batch if they are not in conflict with any of the vehicles currently crossing the junction.

In the algorithm's first part (lines 2-4), the clearIndicator that describes when the junction is empty, and the set previousLayers are initialized. The separations table needs to be built before any scheduling takes place.

In the second part of the algorithm, all the vehicles closest to the junction are collected and form the next batch. Then the optimization of sending vehicles to previous layers is performed, and the remaining vehicles from the new batch. Next, the set of optimal layers is taken from the separations table S, and for each such layer, its velocity is computed so that it will arrive at the junction at the right time. Then the set previousLayers is updated and finally the clearIndicator parameter is updated to the time needed for the layer to cross the junction.

Algorithm 3: changeVelocity(layer, indicator):

| | Result: Calculate the new velocity | |
|---|---|---|
| 1 | maxInd=max{(D/item.vehicle.maxVelocity( ))+time \| item ∈ | |
| | layer} | |
| 2 | if | indicator > maxInd then |
| 3 | \| | maxInd = indicator |
| 4 | end | |
| 5 | for | item ∈ layer do |
| 6 | \| | velocity = D/(maxInd − time) |
| 7 | \| | item.changeVelocity(velocity) |

| | |
|---|---|
| 8 | end |
| 9 | return maxInd |

Algorithm 3 calculates the new velocity for all the vehicles that are coming up to the junction and do not have conflicts. In the first line of the algorithm it calculates the latest arrival time among all vehicles in the layer. The next lines update the parameter maxInd to keep the value of the safe arrival time i.e. when the junction is empty from vehicles. In the last lines the algorithm updates the velocity of all the vehicles in the layer according to the safe arrival time and returns this value for updating the next layer.

Algorithm 4: scheduleInToPreviousLayers(batch, previousLayers):

| | Result: schedule the arrival time according to the previous layer's | | | |
|---|---|---|---|---|
| | | | timing | |
| 1 | for element ∈ batch do | | | |
| 2 | \| | vehicle = element.vehicle | | |
| 3 | \| | minArrivalTime = D/vehicle.maxVelocity( ) | | |
| 4 | \| | layers = previousLayers. getLayersByTime(minArrivalTime) | | |
| 5 | \| | (validLayer,validT) = φ | | |
| 6 | \| | for | (layer,t) ∈ layers do | |
| 7 | \| | \| | if | layer.IsValid(element) then |
| 8 | \| | \| | \| | (validLayer,validT) = (layer,t) |

| 9 | \| | \| | end |
|---|---|---|---|
| 10 | \| | end | |
| 11 | \| | if layer ≠ φ then | |
| 12 | \| | \| | velocity = D/(validT − time) |
| 13 | \| | \| | vehicle.changeVelocity(velocity) |
| 14 | \| | \| | batch = batch\element |

| | | |
|---|---|---|
| 15 | \| | end |

| | |
|---|---|
| 16 | end |

Algorithm 4 performs the optimization mentioned above. In the first line of the algorithm, it calculates the latest arrival time among all vehicles in the layer. The next lines find the layers which are relevant for this vehicle, and for each such layer, it checks whether this vehicle can join the layer, i.e. has no conflicts with it. If the layer is valid, the vehicle velocity must be updated so it will cross the junction together with the other vehicles in the layer.

The algorithm can be applied to the case in which the vehicle currently in the junction is part of a platoon. There are several ways to preserve the platoon. One way is to increase the possible distance between two consecutive vehicles in a platoon. Another way is to decrease the velocity of the vehicle after it crosses the junction (it can be implemented by a virtual traffic sign “speed limit for a platoon”) so that the next vehicle will still arrive at the allowed distance (a combination of both options is also possible). The algorithm details are omitted from this version.

### Objects Definitions

nₜ is the number of vehicles in the simulation in time t.
α is the maximum time that take to any vehicle to cross the junction in maximum velocity.
atMinᵥ is the minimum time that take to vehicle v to arrive the junction.

### Time Complexity of the Update of the Simulation Per Time-Unit:

all the vehicles updating location. Θ(nₜ)
for all the vehicles in batchₜ. O(L)

$$schedule in previous layes . O ( \frac{t - {atMin}_{v}}{α} log ( \frac{t - {atMin}_{v}}{α} ) )$$

schedule in new layers the remaining vehicles of the batchₜ. O(1)

### Total Time Complexity:

$$O ( {n}_{t} + L \cdot \frac{t - {atMin}_{v}}{α} log ( \frac{t - {atMin}_{v}}{α} ) )$$

### Correctness Proof

The separation layers which is calculated and stored in table S in the algorithm 5 for any possible set batch is optimal solution.
Proof: We will prove by induction that, for any |batch| the claim is apply.
Base Case: When |batch|=1 the optimal separation is layers=batch, so as it is in the algorithm 5 line 20.
Induction Hypothesis: Assume that the claim applies for any set batch such that |batch|<N.
Induction Step: Examine all the possible (and non-expandable) subsets of the set batch. For each such subset which is a candidate to be the first layer in the list layers, by the induction assumption, the separation of the other elements in the set batch (batch\layer) is optimal. Since the algorithm examines every subset that is defined to be in the first layer and calculates the optimal solution for the set batch, where |batch|=N, therefore it returns the separation for the set batch with size N, and the solution is at least as good as the optimal solution.

Formally, for a set batch where |batch|=N, define an optimal separation layers*=[l₁, l₂, . . . , lₖ]. Also, define the parameter X* to be the sum of the waiting time of all the elements in the set batch. Where the sum X* is computed according to the separation layers*, and the sum of the waiting time is X*. That means, for every different separation layers for the set batch, it holds that X*≤X where X is the sum of the waiting time of all the elements in the set batch, and the sum X is computed according to the separation layers.

Denote the separation layers'=layers*\l₁=[l₂, l₃, . . . , lₖ] to be a separation for the set batch′ such that batch′=∪ᵢ₌₂^{k}{element∈|lᵢ|lᵢ∈layers*}, i.e. batch′ is a set of all the elements in the set batch which are not in the layer l₁. Assume without generality restriction that |l₁|=n. Therefore, |batch′|=N−n.

Now, compare the separation layers' and the separation layers″=[l″₁, l″₂, . . . , l″ₘ] such that, the separation layers″ is calculated and stored in table S for the set batch′. By induction hypothesis the separation layers″ is an optimal solution for the set batch′ and hence, X″≤X′, where X″, X′ are the sums of the waiting time of all the elements in the set batch′ and is computed according to the separation layers″, layers' respectively.

Define the separation layers″=[l₁, l″₁, l″₂, . . . , l″ₘ] is valid for the set batch, and the sum of the waiting time of all the elements in the set batch, when the sum is computed according to the separation layers′″ is X′″=X″+N.

Since, X″≤X′(X″+N)≤(X′+N) (X″+N)≤X*:X′=X*−N. However, from the optimality of the separation layers follows that (X″+N)=X*.

Since the algorithm considers every possible l₁, therefore, the separation layers′″ is the optimal separation for the set batch. Hence algorithm 1 generates the optimal separation for any possible batch.

The goal is to schedule a starting time driving for a vehicle in a given path P without collisions or changing velocity that is unnecessary during the driving (a path is defined as a series of junctions from source to destination).

The motivation is managing the driving of vehicles on the road efficiently so that they will be able to get from a source point to a destination without stopping and without unforeseen accidents.

### Definitions

Map=(V,E) is the map area as a directed graph whose nodes are junctions and the edges represent the lanes connecting the junctions, we can transform such a map from Google Maps.
G=(GV,GE) is the conflict graph as a directed graph whose nodes are junctions and the edges represent the lanes connecting the junctions, as above, and every node v∈GV has the following parameters:
vehiclesList is a sorted dictionary list of vehicles that are planning to cross the junction at the current time or in the future and, their arrival time (sorted by arrival time).
length is a value of the time in seconds it takes any vehicle to cross the junction.
c(v) is defined as the group of nodes that node v has conflict with, where node v represent a lane that is entering the junction.
Pbatchₜ is the group of vehicles that are asking for a schedule for path P in the time-unit t.
Playerₜ^{T} is defined as the subset of vehicles belonging to Pbatchₜ that can start their drive at the same time T and can cross all the junctions in their path P without collisions.

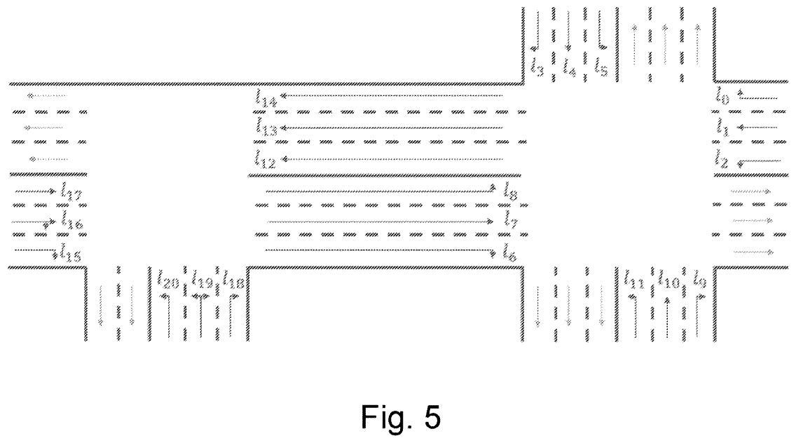

FIG. 4 presented the transformation of part of the SUMO simulation map (SUMO, can be based on Google Maps).

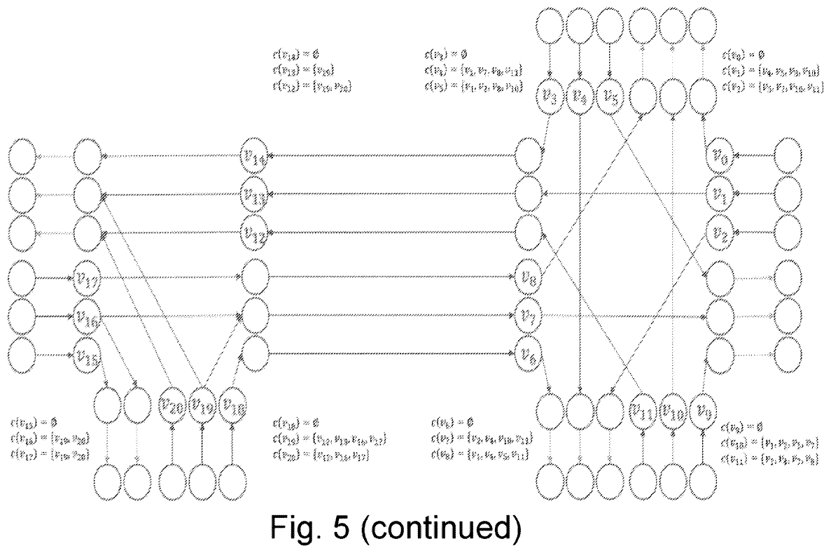

FIG. 5 presents an example of two junctions and the transformation to the conflict graph with the marking of the conflicts for each node c(v).

For every two nodes v₁, v₂ that conflict with each other, in their lists vehicleList we request that the following constraint is satisfied: there are no vehicles from the two nodes that can reach the junction at the same time.

As explained above, the goal of the algorithm is to find the optimal schedule for each Pbatch, where the optimal schedule is to generate the optimal division into Players. The problem of finding the optimal division into Players for a Pbatch is NP-hard (can be reduced to [16]) and does not have a polynomial solution that is both efficient and accurate. A greedy algorithm solves this problem.

First, the scheme Map that represents the map area is built. Second, the function c(lᵢ) is defined and the scheme G=(CV,CE) that represents the conflicts graph which is built according to the function c(lᵢ) where v∈CV represents the end of the lane entering the junction at v.

Next, at each given time-unit t, all the vehicles that are requested for a schedule are collected and called Pbatchₜ. The way for scheduling them is as follows:

Assuming that in time t₀ there is a set Pbatchₜ_{₀} of vehicles that are ready to start moving, each has its path P (set of junctions) and velocity already defined and considering one vehicle after another and construct an arbitrary subset of vehicles that can start the travel at to without any conflict with other vehicles in the set, call it

$${Player}_{{t}_{0}}^{{T}_{1}} ,$$

where T₁=t₀. Next, we need to compute each layer

$${Player}_{{t}_{0}}^{{T}_{i}} .$$

However, to make the algorithm more efficient, this is not done by checking every unit of time. Instead, a range computed and this range is enlarged every iteration until the next

$${Player}_{{t}_{0}}^{{T}_{i}}$$

can be scheduled. The Players are arbitrary sets of vehicles that can start in this range without conflicting with the vehicles which have already been scheduled in layers: t₀, t₁, . . . , tᵢ which are in the map.

After Pbatchₜ_{₀} is completely scheduled, we increment the time unit, the next Pbatchₜ_{₁} of vehicles may be generated, and we start to schedule this Pbatchₜ_{₁} if it is not empty.

Algorithm 5 calculates the time-driving scheduling for the vehicles. First, we build the conflicts graph as described above and, define the constant scale to be the value that represents the scale of the time range in seconds. Then, for every time-unit, we collect all the vehicles that are ready to start driving as Pbatch and schedule them by dividing them into Players. A Player^{T} is a group of vehicles in a Pbatch that do not have conflicts along their driving path and can start driving in the same starting time T. The essence of the algorithm is computing the minimum time T when we can schedule a non-empty Player^{T}. We compute this time iteratively. With each iteration, the range is enlarged, and for the new range we find the minimum time T in the range that a non-empty Player^{T} can be scheduled. This is done by a binary search algorithm. We start by setting T∈[low-up] of the range [low-up]. In the beginning, the time range is 1, which means the optional scheduling time for some Player^{T} is T=t, if Player^{T}≠0, it is scheduled and the set Pbatch is updated (lines 19-22). If not, we search for the time T by finding the middle point of the range and continue searching until we find the minimum T where a non-empty layer exists. Next, the last operations in the while loop (lines 23-28) are defining a new range [low-up], to find schedules for the next Player in the Pbatch. Now the new range becomes twice as large if no Player^{T} was found in the previous range, or gets the value scale back otherwise.

Calculating the largest Player is an NP-Hard problem, since the number of the vehicles that are ready to start driving at a specific time is not limited, so, in the next paragraph, we describe a greedy algorithm to define subsets as Players.

Algorithm 6: getNonConflictItems(conflictsGraph, ListOfVehicles, time):

| | Result: Calculate the subset of vehicles that can start driving | | | | |
|---|---|---|---|---|---|
| | together | | | | |
| 1 | Player=[ ] | | | | |
| 2 | for v ∈ ListOfVehicles do | | | | |
| 3 | \| | P = v.getPath( ) | | | |
| 4 | \| | route = [ ] | | | |
| 5 | \| | flag = True | | | |
| 6 | \| | for j ∈ P do | | | |
| 7 | \| | \| | node=conflictsGraph.getVertex(j) | | |
| 8 | \| | \| | route = route∪ {j} | | |
| 9 | \| | \| | for node′ ∈ node.getC( ) do | | |
| 10 | \| | \| | \| | if conflictsGraph.hasConflict (node′ , v, route, time) then | |
| 11 | \| | \| | \| | \| | flag = False |
| 12 | \| | \| | \| | \| | break |

| 13 | \| | \| | \| | end |
|---|---|---|---|---|
| 14 | \| | \| | end | |
| 15 | \| | \| | if flag is False then | |
| 16 | \| | \| | \| | break |

| 17 | \| | \| | end |
|---|---|---|---|
| 18 | \| | end | |
| 19 | \| | if flag is True then | |
| 20 | \| | \| | Player = Player∪ {v} |
| 21 | \| | \| | conflictsGraph.updateConflictsLists(v) |

| | | |
|---|---|---|
| 22 | \| | end |

| | |
|---|---|
| 23 | end |
| 24 | return Player |

Algorithm 6 calculates the subsets Players^{T} which are the subsets of the vehicles that can start driving at time T, and can travel the entire path without conflicts. At the beginning of the algorithm, the variable Player which is the output of the algorithm is initialized. Then, the algorithm scans the list of vehicles obtained as an argument, from which we build the subset Player as follows.

First, for each vehicle in the list that was received as an argument, we extract the driving path P. Next, we define the variable route that includes the temporary path of the driving path P (from the source to the current junction j). Next, the variable flag is defined, which indicates if vehicle v can cross all the junctions in its path without any collisions (without changing its velocity).

Next, for each node j in the vehicle's path P, we define the variable node, which contains the specific node which the current vehicle arrives to for the current junction and route (the specific lane is part of the path P). The variable route is then updated. Next, the passing possibility of the vehicle is verified according to the conflicts graph, and the variable flag is updated as needed. All the nodes that are potentially in conflict with the current node collected and checked if there is indeed a conflict according to the arrival times (Algorithm 7).

At the end, based on the variable flag, we update the list Player and the conflicts graph or exit the loop to denote that this vehicle cannot pass safely. Note that, in this algorithm, the vehicles are selected in an arbitrary order, which is not necessarily optimal.

Algorithm 7: hasConflict(node, vehicle, route, time):

| | Result: Verify the passing possibility of the vehicle safely | | | |
|---|---|---|---|---|
| 1 | flag = True | | | |
| 2 | at = vehicle.getArrivalTime(time, route, node) | | | |
| 3 | length = node.getLength( ) | | | |
| 4 | vehicleList = node.getVehiclesList( ) | | | |
| 5 | low, up = vehicleList.getInBetween(at) | | | |
| 6 | if up = first and (at + length) ≤ up then | | | |
| 7 | \| | flag = False | | |
| 8 | else | | | |
| 9 | \| | if low = last and (low + length) ≤ at then | | |
| 10 | \| | \| | flag = False | |
| 11 | \| | else | | |
| 12 | \| | \| | if (low + length) ≤ av and (at + length) ≤ up then | |
| 13 | \| | \| | \| | flag = False |

| | | | |
|---|---|---|---|
| 14 | \| | \| | end |

| | | |
|---|---|---|
| 15 | \| | end |

| | |
|---|---|
| 16 | end |
| 17 | return flag |

Algorithm 7 verifies the passing possibility of the vehicles safely, in the specific junction according to the arrival time of each. At the beginning, the variable flag is defined as initialized and will be updated if there are no conflicts. Next, we calculate the arrival time at to the junction node and get the variable length which denotes the time it takes any vehicle to cross the junction.

Then, we get the list of vehicles that are planning to cross the junction at the current time or in the future sorted by arrival time and, set the variables low, up that limit the maximum range of the variable at. Finally, we ensure the safe crossing as follows: if the arrival time of the vehicle is not in the crossing time of any of the list's vehicles then, there is no conflict and flag is updated accordingly.

### Objects Definitions

nₜ is the number of vehicles in the simulation in time t.
nₙ_{ₜ} is the number of new vehicles in the simulation in time t.
v is the number of the vertexes in the road graph.
clearₜ is the value of the time when the map is empty of vehicles.
C is the value of the maximum number of c(l) among all the lanes l.

### Time Complexity of the Update of the Simulation Per Time Unit:

all the vehicles updating location. Θ(nₜ).
for all the new vehicles in the simulation. Θ(nₙ_{ₜ})
   schedule their starting timing by their route. Θ(clearₜ)
   scan the route. O(v)
   verification of non-conflicts. O(C(nₜ log(nₜ)))

### Total Time Complexity:

$$O ( {n}_{t} + {n}_{{n}_{t}} \cdot {clear}_{t} \cdot v \cdot C \cdot {n}_{t} log ( {n}_{t} ) ) \leq O ( {n}_{t}^{2} log ( {n}_{t} ) \cdot {clear}_{t} \cdot v )$$

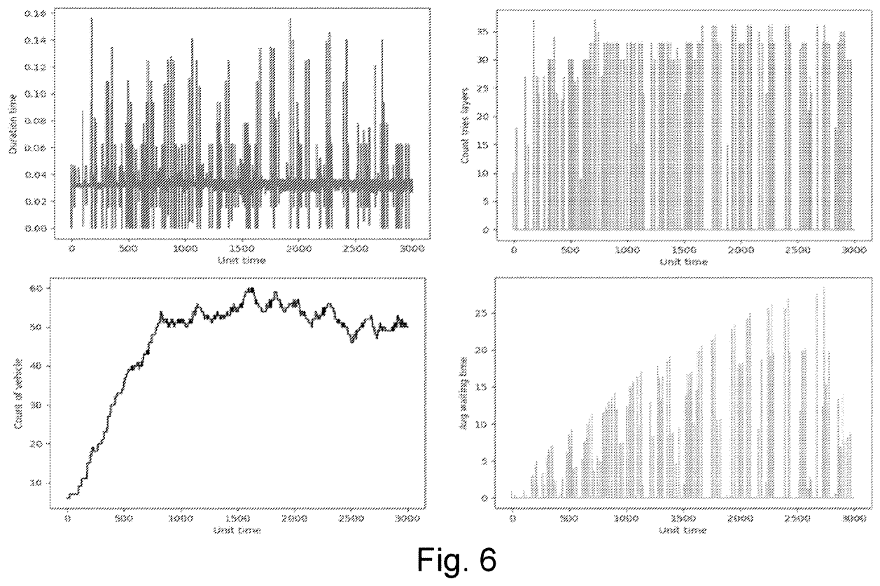

FIG. 6 shows the execution result during 3000 time-units (x-axis) where the parameter scale in the algorithm 5.3 is equal to 10_{sec} and a time-unit is 300ₘₛ. The map area is including 39 junctions and 16 source/destination points. The green graph describes the duration time of the algorithm in seconds (y-axis). The cyan graph describes the number of attempts of creating layers in a batch (y-axis), the yellow graph describes the average waiting time of the vehicles in the batch (y-axis), and the black graph describes the number of vehicles in the simulation (y-axis). Note that the duration time also includes the execution time of the simulation (the simulation was carried over an Intel® Core™ i5-8500 CPU @3.00 GHz PC, with 8.0 GB memory).

From FIG. 6, it can be seen that the correlation between the count of vehicles and the waiting time in every Pbatch is tendentious; when the number of vehicles is going high, the average waiting time in a Pbatch is going high, and vice versa. However, the highest average waiting time is lower than 30 sec.

Additionally, the correlation between the number of vehicles and the number of attempts of creating Players in a Pbatch is tendentious; when the number of vehicles between two Pbatches is going high, the number of attempts of creating Players is going high, and vice versa. However, the highest number of attempts is lower than 40.

The most obvious tendentious correlation that can be recognized is between the number of attempts of creating Players in a Pbatch, and the duration time of the algorithm; when the number of attempts of creating Players is going high, the duration time of the algorithm is going high, and vice versa. However, the highest duration time of the algorithm is 0.16 sec.

When the map is larger the calculation time becomes also larger. Therefore, running the algorithm on a world map requires a computer with stronger and faster computing power than the computer mentioned above.

### Routing and Scheduling

During each time unit, the algorithm will find for all of the new vehicles in the working environment their next action within the route and travel time scheduling. By observing the following principles: (a) minimization of the travel time and (b) continuous travel. The algorithm will find the shortest path in time from the source to the destination that does not allow any stops at any intersections.

### Definitions and Criteria

The following definitions build upon each other to form the final scheme.
G=(V,E): A directed graph that represents the map area. Whose nodes V are junctions, and the edges E represent the directed lanes connecting the junctions.
c:E→ [symbol] : The function c marks the capacity of number of vehicles.
t:E→ [symbol] : The function t marks the duration of the crossing.
G′=(E′,V′) be a variant of the graph G as follow:

$${V}^{′} = {V}_{1} ⋃ {V}_{2} ⋃ {V}_{3}$$

$${V}_{1} = V$$

$${V}_{2} = \{ v \vert v is a conflict crossing point \}$$

$${V}_{3} = \{ {v}^{′} \vert v ∈ {V}_{2} \}$$

$${E}^{′} = {E}_{1} ⋃ {E}_{2} ⋃ {E}_{3}$$

$${E}_{1} = \{ ( x , l ) , ( {l}^{′} , y ) \vert ∀ ( x , y ) ∈$$

E and l is a conflict crossing point on (x,y)}

$${E}_{2} = \{ ( v , {v}^{′} ) \vert ∀ v ∈ {V}_{2} and {v}^{′} ∈ {V}_{3} \}$$

$${E}_{3} = E ∖ \{ ( x , y ) \vert ( x , y ) ∈$$

E and there is a conflict crossing point on (x,y)}

$$c : E \to ℕ$$

$$c ( e ) = 1 \vert ∀ e ∈ {E}_{2}$$

$$c ( e ) = capacity by the map , ∀ e ∈ \{ {E}_{1} ⋃ {E}_{3} \}$$

$$t : E \to ℕ$$

$$t ( e ) = time by the map , ∀ e ∈ {E}^{′}$$

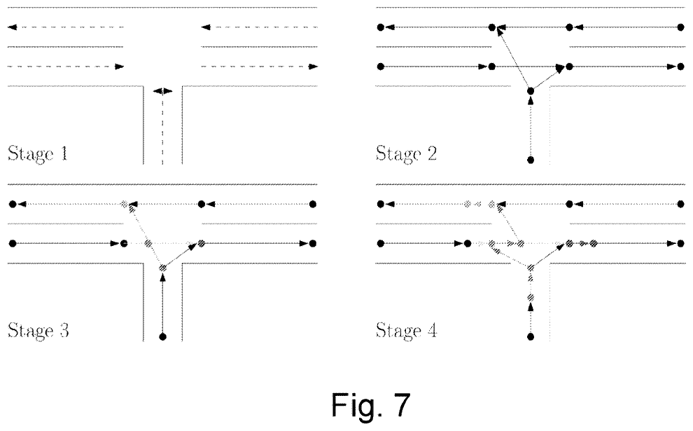

FIG. 7 illustrates the process of creating the graph G′, in four stages. In stage 1, an arbitrary road map is shown. Stage 2 depicts the map topology, which is generated by the SUMO simulator. In stage 3, conflict points on the road are highlighted with different colors (red, blue, green, and pink). Finally, in stage 4, the complete conflict variant graph of the map topology graph is shown, where the colored edges (red, blue, green, and pink) correspond to the crossing conflict points.

As can be seen from the graph in FIG. 7, there are two types of conflict points in the graph: (1) those located on the lanes (e.g., the red points on the yellow and purple edges) and (2) those located at the nodes (e.g., the green node). Conflict points of type 1 split the edges that they are located on into two parts, before and after the conflict point, whereas conflict points of both type 1 and 2 are split into two separate points connected by an edge with capacity 1.

Given a directed graph G=(V,E) that represents the map topology, we construct the variant graph G′=(V′,E′) according to the specified procedure above. Then, we split all edges e∈E₁∪E₃ into t(e) edges, where t(e) is a given function which describe a time-unit.

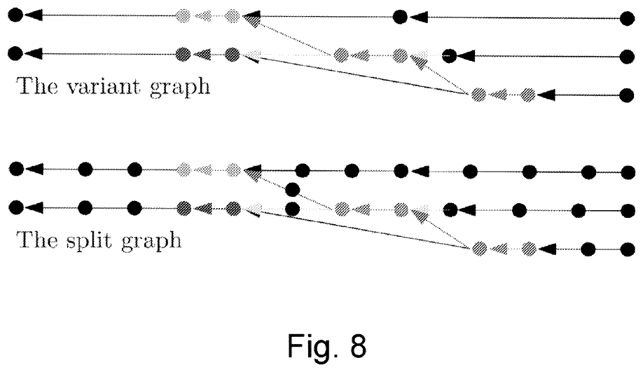

FIG. 8 shows the split of edges in the variant graph, which corresponds to the variant graph shown in FIG. 7 at stage 4. The variant graph in FIG. 8 is the same as the variant graph depicted in FIG. 7 Stage 4, but with a different arrangement of the edges.

Afterward, the graph G′ is duplicated into T layers, where T is the longest path with time and, each layer contains all graph nodes, and every consecutive layers include all edges between them.

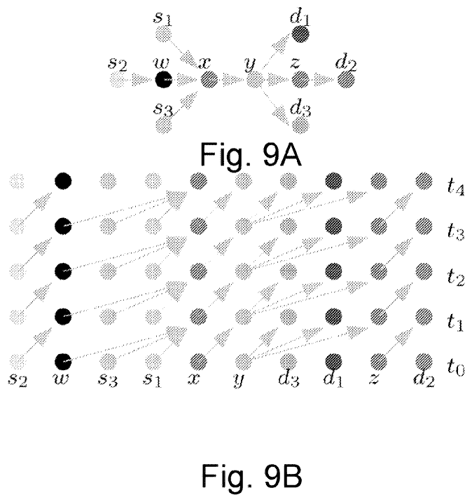

FIG. 9a shows an example of an arbitrary split graph and FIG. 9b shows the transformation to layers graph, where T=5.

Sequential Prioritized Scheduling with Dijkstra's Algorithm

Given a sequence of pairs, denoted as S=[(s₁,d₁), (s₂,d₂), . . . , (sₖ,dₖ)], each pair is optimally scheduled, based on the network stage, where optimal scheduling is the earliest arrival time. The sequence S is ordered by priority.

First, the layers graph LG are construct as described earlier, consisting of T layers. Then, for each pair pᵢ=(sᵢ, dᵢ), the best route in LG is determined as follows: a copy s_{i′} of the node sᵢ is created and connected to all nodes sᵢ_{ⱼ} where 0≤j≤T (i.e., (s_{i′},sᵢ_{ⱼ})) with time function t((s_{i′},sᵢ_{ⱼ}))=j. Similarly, the copied node d_{i′} is connected to all nodes dᵢ_{ⱼ} where 0≤j≤T (i.e., (dᵢ_{ⱼ},d_{i′})) with time function t((dᵢ_{ⱼ},d_{i′}))=0.

Next, the Dijkstra's algorithm is utilized to find the optimal route Pᵢ for the pair pᵢ. If no route is found, T additional layers are added to the layer graph and the copied nodes are connected to them as described above, to ensure that pᵢ will have a route. Then, the Dijkstra's algorithm is applied again.

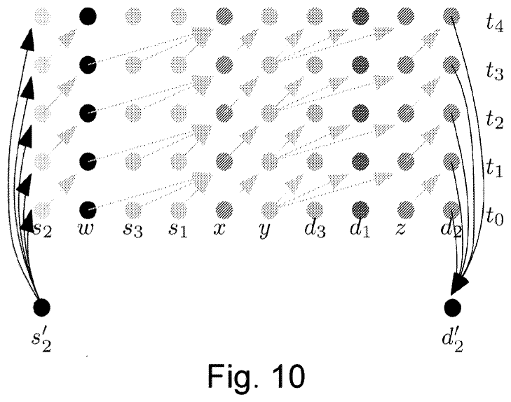

FIG. 10 shows an example of pair p₂=(s₂,d₂) and, the route network transformation.

Finally, the copied nodes s_{i′} and d_{i′} are removed from the layers graph LG, along with the edges connected to them. Additionally, the edges corresponding to the optimal route Pᵢ are deleted, where their capacity is one. The capacity of the remaining edges of the route Pᵢ are decreased by one.

### Multi Commodity Flow Based Algorithm

First, information about all the vehicles that are ready to drive at each given time-unit t>1 are collected, thereby creating a set batchₜ={(v,s,d,rt=∞)|(v,s,d,rt):X×V×V× [symbol] }, where v is the vehicle ID, s is the source, d is the destination and t is the route time to get the destination. After that, the set batchₜ in consideration with the set batchₜ₋₁, which consists of all vehicles scheduled before is also scheduled.

Next, the nodes groups Sₜ and Dₜ, representing the source and destination nodes of the vehicles in set batchₜ and batchₜ₋₁ are added to the layers graph LG. A copy s′ is created for each node s∈Sₜ that connect it to all nodes sᵢ where 0≤i≤T (i.e (s′,sᵢ)). Differently, all nodes dᵢ are connected to each copied node d′ of d∈Dₜ where 0≤i≤T (i.e (dᵢ,d′). Finally 2 more nodes Sₜ and Dₜ are added, which are connected to the copied node s's and d's respectively.

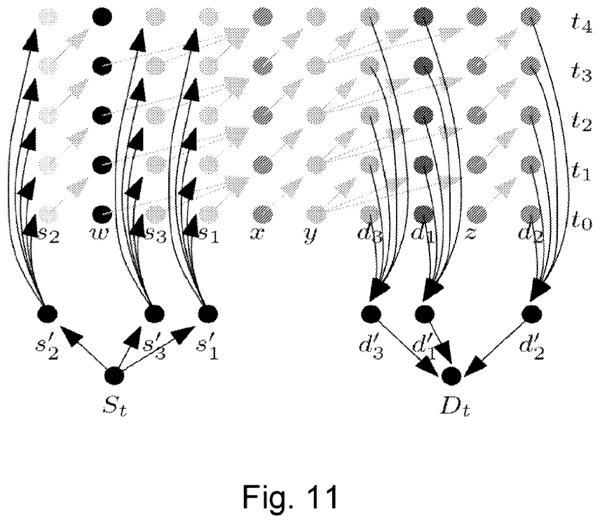

FIG. 11 shows an example of batchₜ={(v₁,s₁,d₁,∞), (v₂,s₂,d₂,∞), (v₃,s₃,d₃,∞)} and the flow network transformation.

Then, the Multi Commodity Flow Over Time (MCFOT) algorithm is applied to find the optimal route for all vehicles, while ensuring that the route time is lesser than the previous value. If it is, one more layer us added to the layer graph and the MCFOT algorithm is applied again.

### Multi-Commodity Flow Over Time

Is a problem of optimizing the transport of several commodities between various locations over a given period. It aims to schedule the flow of multiple commodities across a transportation network, while meeting demand requirements, minimizing costs, and satisfying capacity constraints. That is, to find an optimal flow plan for each commodity, which satisfies the network's constraints and is feasible for the given time horizon. This problem is particularly important in traffic transportation and logistics, where it is essential to allocate resources efficiently to meet demand while minimizing costs.

In more general terms, the invention is directed to a method for efficient real-time traffic management of controllable autonomic and non-autonomic vehicles, moving between sources and destinations, comprising:
a) scheduling and synchronizing the movement of autonomic and non-autonomic vehicles approaching junctions between source and destination;
b) displaying to the driver of each non-autonomic vehicle or transmitting to each autonomic vehicle, the speed required for allowing the vehicle to cross each junction without stopping, while eliminating conflicts with other vehicles, for achieving non-stop junctions; and
c) scheduling and synchronizing the movement of a plurality of vehicles that join and leave the traffic, for allowing a non-stop movement from source to destination.

The method may further comprise the steps of:
a) collecting data regarding source and destination of each vehicle;
b) generating for each vehicle, based on the data collected for all other vehicles, an optimal path from its corresponding source to destination that allows a non-stop movement from source to destination.

The invention is also directed to a method for efficient real-time traffic management of controllable vehicles belonging to a platoon in a predetermined area, comprising:
a) converting a map of the predetermined area to a directed graph;
b) selecting a representative vehicle for the platoon;
c) associating all vehicles being transitively closer to each other than a predetermined distance from the representative vehicle, to the platoon; and
d) tracking and replaying the movements of each vehicle in the platoon upon reaching the location of the representative vehicle.

The invention is also directed to a method for efficient real-time traffic management of controllable vehicles belonging to a platoon, comprising:
a) collecting the location data of each controllable vehicle to construct a map;
b) converting the map to a directed graph, the node of which represent junctions and the edges of which represent lanes;
c) for each vehicle in the platoon, determining a corresponding edge in the directed graph and a corresponding location on the edge;
d) selecting a representative vehicle for the platoon;
e) scanning all vehicles in the directed graph that move in the same direction as the representative vehicle;
f) scanning all vehicles in the directed graph that move along edges that merge with the edge of the representative vehicle;
g) generating a platoon by including all vehicles, the distance of which from a vehicle in the platoon, where the first vehicle in the platoon is the representative vehicle is below a predetermined threshold, as belonging to the platoon;
h) selecting the first vehicle in the platoon as a leading vehicle; and
i) sending movement commands to leading and allowing the other vehicles and to follow the leading vehicle as a firming vehicle being alternative to a train.

The method may further comprise the steps of generating virtual traffic policies including real-time generation of virtual signs that are transmitted or displayed to each controllable vehicle from a traffic management center and/or a programmable road sign.

The invention is also directed to a method for real-time traffic management of controllable vehicles approaching a junction to pass the junction without stopping, comprising:
a) at each predetermined time unit, generating batches of vehicles being closer than a predetermined distance D from the junction, where each batch comprises vehicles with possibly known approaching lane and direction;
b) for each junction, generating a table of layers, each of which containing vehicles that can cross the junction without conflicts;
c) checking if vehicles from a later batch can enter lanes of other layers and if they can, allowing the vehicles to enter the lanes;
d) for each approaching vehicle, calculating the moving speed for approaching the junction, such that the approaching vehicle will cross the junction safely without stopping and without conflicts with other approaching vehicles; and
e) transmitting and/or display, in a programmable road sign, to each approaching vehicle the correct timing for safely crossing the junction.

The table of layers may be generated in a preprocessing offline, using dynamic programming.

The invention is also directed to a method for global real-time traffic management for scheduling vehicles entrance to the traffic to reach its destination without stopping, comprising:
a) collecting the location data of each controllable vehicle either via direct communication or via satellites, airplane, drones or cameras to construct a map;
b) converting the map to a directed graph, the node of which represent junctions and the edges of which represent lanes;
c) identifying potential conflict points on the directed graph;
d) splitting each conflict point to an additional edge, to generate a split graph that enforces respecting one vehicle at a time in all conflicting locations;
e) at each predetermined time unit, scheduling the arriving batch of vehicles to start a journey from a source, being the location to a destination;
f) generating a table of layers, each of which containing vehicles that can cross the junction without conflicts;
g) for each source and destination, seeking the shortest path on the split graph that connects between source and destination, while eliminating edges, via which a vehicle has passed during a preceding time unit; and
h) for each vehicle in a batch, determining the timing at which the vehicle crosses each junction without conflicts with other vehicles.

Finding the shortest path may be performed using the Dijkstra's Algorithm.

The timing may be determined using the Multi commodity Flow Based Algorithm, by:
a) transferring a single execution of multi commodity flow into a continuous execution of multi-commodity flow by introducing new intermediate nodes into the graph, such that a vehicle can start from the intermediate nodes, if the vehicle reached the node after one time unit since the previous computation of the multi commodity flow solution, the multi-commodity flow allows maximum flow of vehicles through the network; and
b) postponing the entrances of new vehicles that cause a delay in the arrival time of vehicles that started their journey.

The virtual traffic policies comprises one or more of the following:
the same driving instructions given to the leading vehicle at a particular point along the road are given to the other platoon members when they arrive at the same particular point;
all the vehicles in the platoon get the same Maximum Speed limit;
all the vehicles in the platoon which are on the same lane will move at the same speed;
Lane blocking for all kind of vehicles;
Distance keeping among vehicles in a platoon;
Reversing lane direction;
directing vehicle to use detour through emergency lanes and reversed lane of the opposite direction road;
using Virtual Traffic Lights;
real-time generation of virtual signs that are transmitted to each controllable vehicle from a traffic management center and/or a programmable road sign.

Determining the timing may be done such that priority between the lanes entering the junction is equal.

The table may comprise all possible batches with precomputed optimal separation into layers for each batch.

Scheduling may be performed by:
a) at each given time-unit t, collecting all of the vehicles that are close to the junction at distance D;
b) for every vehicle in a batch, checking the possibility of joining to an existing layer that was received by the previous batches scheduling their crossing time;
c) allowing vehicles from a current batch to join previous layers;
d) updating the current batch with a reduced set of vehicles;
e) obtaining the optimal separation into new layers from the table, for the remaining vehicles;
f) determining the crossing time T for each layer;
g) For each layer in the current batch that has passed the junction, setting an indication when the junction is empty; and
h) updating the vehicle velocity by the distance and their calculated crossing time.

The invention is also directed to a method for determining platoons of vehicles, comprising performing transformation of a location map into measurements of a distance between vehicles, being a function of the speed of the vehicle, measuring speed by tracing location and time to notify nearby vehicles on the opportunity to a platoon, by speeding or slowing down.

The distance and speed may be used to determine a safety distance for each vehicle while crossing a junction.

The threshold distance to join a platoon may be larger than the distance between consecutive vehicles but is sufficiently small for encouraging vehicles behind the platoon to accelerate and vehicles in front of the platoon to decelerate and join the platoon.

The platoon may consist of a plurality of trucks operated by transport services providers that are jointly controlled to travel from a source to a destination.

The invention is also directed to a system for efficient real-time traffic management of controllable autonomic and non-autonomic vehicles, moving between sources and destinations, comprising:
d) a computerized device comprising at least one processor, for scheduling and synchronizing the movement of autonomic and non-autonomic vehicles approaching junctions between source and destination;
e) a display device, controlled by commands sent from the computerized device, for displaying to the driver of each non-autonomic vehicle or transmitting to each autonomic vehicle, the speed required for allowing the vehicle to cross each junction without stopping, while eliminating conflicts with other vehicles, for achieving non-stop junctions; and
f) scheduling and synchronizing the movement of a plurality of vehicles that join and leave the traffic, for allowing a non-stop movement from source to destination.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

### REFERENCES

[1] P. A. Lopez, M. Behrisch, L. Bieker-Walz, J. Erdmann, Y.-P. FI\ddot{ }otter\ddot{ }od, R. Hilbrich, L. L\ddot{ }ucken, J. Rummel, P. Wagner, E. Wiesner, Microscopic traffic simulation using sumo, in: The 21st IEEE International Conference on Intelligent Transportation Systems, IEEE, 2018.
[2] W. Zhao, D. Ngoduy, S. Shepherd, R. Liu, M. Papageorgiou, A platoon based cooperative eco-driving model for mixed automated and humandriven vehicles at a signalised intersection, Transportation Research Part C: Emerging Technologies 95 (2018) 802-821.
[3] S. Dolev, E. Gudes, H. Yair, Automatic real time platoon formation using the road graph, in: 2021 IEEE 20th International Symposium on Network Computing and Applications (NCA), IEEE Computer Society, Los Alamitos, CA, USA, 2021, pp. 1-4.
[4] S. Dolev, E. Gudes, H. Yair, Non-stopping junctions via traffic scheduling, in: Cyber Security, Cryptology, and Machine Learning: 6th International Symposium, CSCML 2022, Be′ er Sheva, Israel, Jun. 30-Jul. 1, 2022, Proceedings, Springer-Verlag, Berlin, Heidelberg, 2022, p. 247-258. doi: 10.1007/978-3-031-07689-3_19.
[5] Demonstration video (2022). URL https://drive.google.com/file/d/1-R2n7-aqiLFBNtfJe3FH4NDB4uMZuz31/view?usp=sharing
[6] J. J. B. Vial, W. E. Devanny, D. Eppstein, M. T. Goodrich, Scheduling Autonomous Vehicle Platoons Through an Unregulated Intersection, in: M. Goerigk, R. Werneck (Eds.), 16th Workshop on Algorithmic Approaches for Transportation Modelling, Optimization, and Systems (ATMOS 2016), Vol. 54 of OpenAccess Series in Informatics (OASIcs), Schloss Dagstuhl-Leibniz-Zentrum fuer Informatik, Dagstuhl, Germany, 2016, pp. 5:1-5:14.
[7] S. Dolev, E. Kranakis, D. Krizanc, Baked-potato routing, J. Algorithms 30 (2) (1999) 379-399.
[8] N. Li, S. Chen, J. Zhu, D. J. Sun, A platoon-based adaptive signal control method with connected vehicle technology, Comput. Intell. Neurosci. 2020 (2020) 2764576:1-2764576:10.
[9] C. Olaverri-Monreal, P. Gomes, M. K. Silv eria, M. Ferreira, In-vehicle virtual traffic lights: A graphical user interface, in: 7th Iberian Conference on Information Systems and Technologies (CISTI 2012), 2012, pp. 1-6.
[10] K. M. Ng, M. B. I. Reaz, Platoon interactions and real-world traffic simulation and validation based on the lwr-im, PLOS ONE 11 (2016) 1-17.
[11] H. Concei, c^{˜}ao, M. Ferreira, P. Steenkiste, Virtual traffic lights in partial deployment scenarios, in: 2013 IEEE Intelligent Vehicles Symposium (IV), Gold Coast City, Australia, Jun. 23-26, 2013, IEEE, pp. 988-993.
[12] A. Bazzi, A. Zanella, B. M. Masini, G. Pasolini, A distributed algorithm for virtual traffic lights with IEEE 802.11p, in: European Conference on Networks and Communications, EuCNC 2014, Bologna, Italy, Jun. 23-26, 2014, IEEE, pp. 1-5.
[13] W. Viriyasitavat, J. M. Roldan, O. K. Tonguz, Accelerating the adoption of virtual traffic lights through policy decisions, in: International Conference on Connected Vehicles and Expo, ICCVE 2012, Las Vegas, NV, USA, Dec. 2-6, 2013, IEEE, pp. 443-444.
[14] F. Happach, L. Hellerstein, T. Lidbetter, A general framework for approximating min sum ordering problems (2020). doi:10.48550/ARXIV. 2004.05954. URL https://arxiv.org/abs/2004.05954
[15] S. Dolev, A. Kesselman, Bounded latency scheduling scheme for atm cells, Computer Networks 32 (3) (2000) 325-331. doi: https://doi.org/10.1016/S1389-1286 (00) 00002-5. URL https://www.sciencedirect.com/science/article/pii/S1389128600000025
[16] J. Ullman, Np-complete scheduling problems, Journal of Computer and System Sciences 10 (3) (1975) 384-393. doi: https:
17. Barbehenn, M.: A note on the complexity of dijkstra's algorithm for graphs with weighted vertices. IEEE transactions on computers 47 (2), 263 (1998)
18. Bevrani, B., Burdett, R., Bhaskar, A., Yarlagadda, P. K.: A multi-criteria multi-commodity flow model for analysing transportation networks. Operations Research Perspectives 7, 100159 (2020)
19. Even, S., Itai, A., Shamir, A.: On the complexity of time table and multi-commodity flow problems. In: 16th annual symposium on foundations of computer science (sfcs 1975). pp. 184-193. IEEE (1975)
20. Gupta, S. P., Pyakurel, U., Dhamala, T. N.: Multi-commodity flow problem on lossy network with partial lane reversals. Annals of Operations Research 323 (1-2), 45-63 (2023)
21. Herty, M., Kirchner, C., Moutari, S., Rascle, M.: Multicommodity flows on road networks (2008)
22. Karakostas, G.: Faster approximation schemes for fractional multicommodity flow problems. ACM Transactions on Algorithms (TALG) 4 (1), 1-17 (2008)
23. Lopez, P. A., Behrisch, M., Bieker-Walz, L., Erdmann, J., Flötteröd, Y. P., Hilbrich, R., Lücken, L., Rummel, J., Wagner, P., Wießner, E.: Microscopic traffic simulation using sumo. In: The 21st IEEE International Conference on Intelligent Transportation Systems. IEEE (2018)
24. Pyakurel, U., Gupta, S. P., Khanal, D. P., Dhamala, T. N.: Efficient algorithms on multicommodity flow over time problems with partial lane reversals. International Journal of Mathematics and Mathematical Sciences 2020, 1-13 (2020)

1. A method for efficient real-time traffic management of controllable autonomic and non-autonomic vehicles, moving between sources and destinations, comprising:
a) scheduling and synchronizing the movement of autonomic and non-autonomic vehicles approaching junctions between source and destination;
b) displaying to the driver of each non-autonomic vehicle or transmitting to each autonomic vehicle, the speed required for allowing said vehicle to cross each junction without stopping, while eliminating conflicts with other vehicles, for achieving non-stop junctions; and
c) scheduling and synchronizing the movement of a plurality of vehicles that join and leave the traffic, for allowing a non-stop movement from source to destination.

2. A method according to claim 1, further comprising:
a) collecting data regarding source and destination of each vehicle;
b) generating for each vehicle, based on the data collected for all other vehicles, an optimal path from its corresponding source to destination that allows a non-stop movement from source to destination.

3. A method for efficient real-time traffic management of controllable vehicles belonging to a platoon in a predetermined area, comprising:
a) converting a map of said predetermined area to a directed graph;
b) selecting a representative vehicle for said platoon;
c) associating all vehicles being transitively closer to each other than a predetermined distance from said representative vehicle, to said platoon;
d) tracking and replaying the movements of each vehicle in said platoon upon reaching the location of said representative vehicle.

4. A method for efficient real-time traffic management of controllable vehicles belonging to a platoon, comprising:
a) collecting the location data of each controllable vehicle to construct a map;
b) converting said map to a directed graph, the node of which represent junctions and the edges of which represent lanes;
c) for each vehicle in said platoon, determining a corresponding edge in said directed graph and a corresponding location on said edge;
d) selecting a representative vehicle for said platoon;
e) scanning all vehicles in said directed graph that move in the same direction as said representative vehicle;
f) scanning all vehicles in said directed graph that move along edges that merge with the edge of said representative vehicle;
g) generating a platoon by including all vehicles, the distance of which from a vehicle in said platoon, where the first vehicle in said platoon is said representative vehicle is below a predetermined threshold, as belonging to said platoon;
h) selecting the first vehicle in said platoon as a leading vehicle; and
i) sending movement commands to leading and allowing the other vehicles and to follow said leading vehicle as a firming vehicle being alternative to a train.

5. A method according to claim 1, further comprising generating virtual traffic policies including real-time generation of virtual signs that are transmitted or displayed to each controllable vehicle from a traffic management center and/or a programmable road sign.

6. A method for real-time traffic management of controllable vehicles approaching a junction to pass said junction without stopping, comprising:
a) at each predetermined time unit, generating batches of vehicles being closer than a predetermined distance D from said junction, where each batch comprises vehicles with possibly known approaching lane and direction;
b) for each junction, generating a table of layers, each of which containing vehicles that can cross said junction without conflicts;
c) checking if vehicles from a later batch can enter lanes of other layers and if they can, allowing said vehicles to enter said lanes;
d) for each approaching vehicle, calculating the moving speed for approaching said junction, such that said approaching vehicle will cross said junction safely without stopping and without conflicts with other approaching vehicles; and
e) transmitting and/or display, in a programmable road sign, to each approaching vehicle the correct timing for safely crossing said junction.

7. A method according to claim 1, wherein the table of layers is generated in a preprocessing offline, using dynamic programming.

8. A method for global real-time traffic management for scheduling vehicles entrance to the traffic to reach its destination without stopping, comprising:
a) collecting the location data of each controllable vehicle either via direct communication or via satellites, airplane, drones or cameras to construct a map;
b) converting said map to a directed graph, the node of which represent junctions and the edges of which represent lanes;
c) identifying potential conflict points on said directed graph;
d) splitting each conflict point to an additional edge, to generate a split graph that enforces respecting one vehicle at a time in all conflicting locations;
e) at each predetermined time unit, scheduling the arriving batch of vehicles to start a journey from a source, being the location to a destination;
f) generating a table of layers, each of which containing vehicles that can cross said junction without conflicts;
g) for each source and destination, seeking the shortest path on said split graph that connects between source and destination, while eliminating edges, via which a vehicle has passed during a preceding time unit; and
h) for each vehicle in a batch, determining the timing at which said vehicle crosses each junction without conflicts with other vehicles.

9. A method according to claim 8, wherein finding the shortest path is performed using the Dijkstra's Algorithm.

10. A method according to claim 8, wherein the timing is determined using the Multi commodity Flow Based Algorithm, by:
a) transferring a single execution of multi commodity flow into a continuous execution of multi-commodity flow by introducing new intermediate nodes into the graph, such that a vehicle can start from said intermediate nodes, if said vehicle reached said node after one time unit since the previous computation of the multi commodity flow solution, said multi-commodity flow allows maximum flow of vehicles through the network; and
b) postponing the entrances of new vehicles that cause a delay in the arrival time of vehicles that started their journey.

11. A method according to claim 5, wherein the virtual traffic policies comprise one or more of the following:
the same driving instructions given to the leading vehicle at a particular point along the road are given to the other platoon members when they arrive at the same particular point;
all the vehicles in the platoon get the same Maximum Speed limit;
all the vehicles in the platoon which are on the same lane will move at the same speed;
Lane blocking for all kind of vehicles;
Distance keeping among vehicles in a platoon;
Reversing lane direction;
directing vehicle to use detour through emergency lanes and reversed lane of the opposite direction road;
using Virtual Traffic Lights;
real-time generation of virtual signs that are transmitted to each controllable vehicle from a traffic management center and/or a programmable road sign.

12. A method according to claim 8, wherein determining the timing is done such that priority between the lanes entering the junction is equal.

13. A method according to claim 6, wherein the table comprises all possible batches with precomputed optimal separation into layers for each batch.

14. A method according to claim 1, wherein scheduling is performed by:
a) at each given time-unit t, collecting all of the vehicles that are close to the junction at distance D;
b) for every vehicle in a batch, checking the possibility of joining to an existing layer that was received by the previous batches scheduling their crossing time;
c) allowing vehicles from a current batch to join previous layers;
d) updating said current batch with a reduced set of vehicles;
e) obtaining the optimal separation into new layers from the table, for the remaining vehicles;
f) determining the crossing time T for each layer;
g) For each layer in the current batch that has passed the junction, setting an indication when the junction is empty; and
h) updating the vehicle velocity by the distance and their calculated crossing time.

15. A method for determining platoons of vehicles, comprising performing transformation of a location map into measurements of a distance between vehicles, being a function of the speed of the vehicle, measuring speed by tracing location and time to notify nearby vehicles on the opportunity to a platoon, by speeding or slowing down.

16. A method according to claim 15, wherein the distance and speed are used to determine a safety distance for each vehicle while crossing a junction.

17. A method according to claim 4, wherein the threshold distance to join a platoon is larger than the distance between consecutive vehicles but is sufficiently small for encouraging vehicles behind said platoon to accelerate and vehicles in front of said platoon to decelerate and join said platoon.

18. A method according to claim 4, wherein the platoon consists of a plurality of trucks operated by transport services providers that are jointly controlled to travel from a source to a destination.

19. A system for efficient real-time traffic management of controllable autonomic and non-autonomic vehicles, moving between sources and destinations, comprising:
a) a computerized device comprising at least one processor, for scheduling and synchronizing the movement of autonomic and non-autonomic vehicles approaching junctions between source and destination;
b) a display device, controlled by commands sent from said computerized device, for displaying to the driver of each non-autonomic vehicle or transmitting to each autonomic vehicle, the speed required for allowing said vehicle to cross each junction without stopping, while eliminating conflicts with other vehicles, for achieving non-stop junctions; and
c) scheduling and synchronizing the movement of a plurality of vehicles that join and leave the traffic, for allowing a non-stop movement from source to destination.
